(19) United States
(12) Patent Application Publication
(10) Pub. No.: US 2009/0182774 A1
(43) Pub. Date: Jul. 16, 2009

(54) Method And System For Protocol Operations And Datasets To Manage Object Identification Numbers

(76) Inventor: Scott Krig, Santa Clara, CA (US)

Correspondence Address: MCANDREWS HELD & MALLOY, LTD, 500 WEST MADISON STREET, SUITE 3400, CHICAGO, IL, 60661, US

(21) Appl. No.: 12/195,292

(22) Filed: Aug. 20, 2008

Related U.S. Application Data
(60) Provisional application No. 61/021,502, filed on Jan. 16, 2008.
(60) Provisional application No. 61/077,316, filed on Jul. 1, 2008.

(51) Int. Cl. G06F 17/30

(52) U.S. Cl. 707/104.1; 707/E17.002

(57) ABSTRACT

An extension of media transfer protocol (MTP) is provided which may enable a first device to manage operations involving one or more object identifiers (ObjectIDs) stored within a second device that may correspond to objects stored within the second device. ObjectIDs may be specified in an array within an ObjectID dataset as a range of ObjectIDs and/or as one or more ObjectID values. MTP operations initiated by a first device may enable management of ObjectIDs stored within the second device. For example, a first device may request, via one or more MTP operations, reservation of one or more ObjectIDs, changing of one or more current ObjectIDs and/or searching for one or more ObjectIDs stored within the second device. Subsequently, the first device may receive one or more MTP responses from the second device.

### CROSS-REFERENCE TO RELATED APPLICATIONS/INCORPORATION BY REFERENCE

This application makes reference to, claims priority to, and claims the benefit of U.S. Provisional Application Ser. No. 61/021,502, filed on Jan. 16, 2008, entitled “Method and System for Protocol Operations and Datasets to Manage Object Identification Numbers,” which is hereby incorporated herein by reference in its entirety.

This application makes reference to, claims priority to, and claims the benefit of U.S. Provisional Application Ser. No. 61/077,316, filed on Jul. 1, 2008, entitled “Method and System for Protocol Operations and Datasets to Manage Object Identification Numbers,” which is hereby incorporated herein by reference in its entirety.

### FIELD OF THE INVENTION

Certain embodiments of the invention relate to multimedia communication. More specifically, certain embodiments of the invention relate to a method and system for protocol operations and datasets to manage object identification numbers.

### BACKGROUND OF THE INVENTION

The media transfer protocol (MTP) is an extension of the industry standard picture transfer protocol (PTP). The media transfer protocol was created as an extension to the picture transfer protocol specifically for media devices and includes various provisions for digital rights management (DRM).

Digital rights management (DRM) and electronic license management technologies may be utilized for home video, music, consumer and enterprise software markets. Motion picture studios, cable and satellite TV operators, consumer electronics companies and personal computer manufacturers use DRM technologies to prevent the unauthorized duplication, reception or use of copyrighted video materials.

PIMA 15740:2000 provides a common communication mechanism for exchanging images with and between digital still photography devices (DSPDs). This includes communication between digital still photography devices and host computers, printers, other digital still devices, telecommunications kiosks, and image storage and display devices. This standard presents a protocol that is intended to be transport and platform independent. The purpose of this intent is to enable standard behavior by allowing implementation of the protocol in a variety of standard transports. Exemplary transports include USB (Universal Serial Bus), IEEE 1394, and IrDA (Infrared Data Association). This standard specifies the following:

Behavior requirements for DSPDs include: baseline features a device needs to support to provide interoperability over conforming transports; functional requirements needed by a transport to enable the creation of a transport-dependent implementation specification that conforms to this standard; and a high-level protocol for communicating with and between DSPDs consisting of operation, data, and response phases.

Further limitations and disadvantages of conventional and traditional approaches will become apparent to one of skill in the art, through comparison of such systems with the present invention as set forth in the remainder of the present application with reference to the drawings.

### BRIEF SUMMARY OF THE INVENTION

A system and/or method for protocol operations and datasets to manage object identification numbers, substantially as shown in and/or described in connection with at least one of the figures, as set forth more completely in the claims.

These and other advantages, aspects and novel features of the present invention, as well as details of an illustrated embodiment thereof, will be more fully understood from the following description and drawings.

### BRIEF DESCRIPTION OF SEVERAL VIEWS OF THE DRAWINGS

FIG. 1 is a block diagram of exemplary system for managing MTP ObjectIDs via an extension of the MTP standard, in accordance with an embodiment of the invention.

FIG. 2 is a flow chart illustrating exemplary steps for reserving via a first device, one or more ObjectIDs within a second device, in accordance with an embodiment of the invention.

FIG. 3 is a flow chart illustrating exemplary steps for changing via a first device, one or more ObjectIDs utilized within a second device, in accordance with an embodiment of the invention.

FIG. 4 is a flow chart illustrating exemplary steps for searching via a first device, for one or more ObjectIDs utilized within a second device, in accordance with an embodiment of the invention.

### DETAILED DESCRIPTION OF THE INVENTION

Aspects of the invention may be found in a method and system for protocol operations and datasets to manage object identification numbers. In this regard, an extension of media transfer protocol (MTP) may enable a first device to manage activity involving one or more object identifiers (ObjectIDs) stored within a second device, where the first device and/or second device may be enabled to communicate via MTP. The ObjectIDs may correspond to one or more objects that may be currently stored within the second device or may be subsequently stored within the second device. In this regard, one or more ObjectIDs may be specified as an array within an ObjectID dataset. For example, the one or more ObjectIDs may be expressed as a range of ObjectIDs within the array and/or as one or more ObjectID values within the array. Moreover, MTP operations initiated by the first device may enable management of ObjectIDs stored within the second device. In this regard, the first device may request reservation of one or more ObjectIDs stored within the second device. In addition, a first device may request changing of one or more ObjectIDs corresponding to one or more objects stored within the second device. Moreover, a first device may request a search for one or more ObjectIDs stored within the second device. Subsequent to one or more of the requests via the MTP operation by the first device 102 for management of ObjectIDs stored within the second device 104, the first device 102 may receive one or more MTP responses from the second device 104. Accordingly, the extension of MTP may provide improved functionality and may enable new features for devices that communicate utilizing MTP.

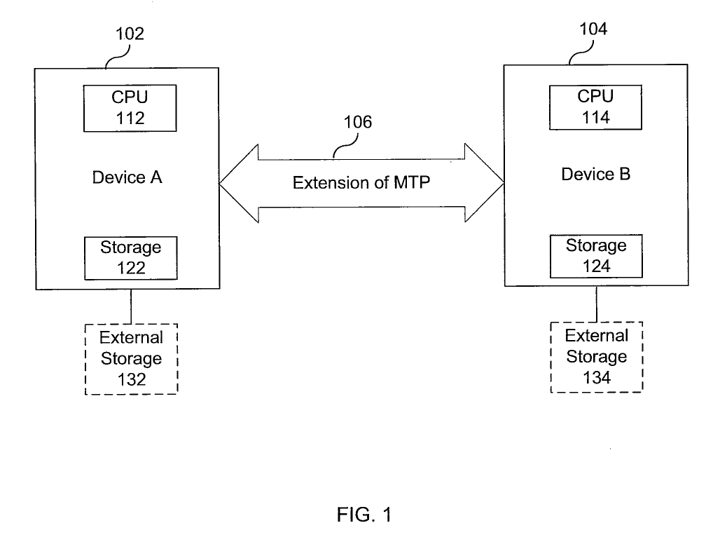

FIG. 1 is a block diagram of exemplary system for managing MTP object IDs via an extension of the MTP standard, in accordance with an embodiment of the invention. Referring to FIG. 1 there is shown an extension of the media transfer protocol (MTP) 106 that may facilitate communication between a device 102 and a device 104. The devices 102 and 104 may comprise processors 112 and 114 respectively, internal storage 122 and 124 respectively and/or external storage 132 and 134 respectively.

The device 102 may comprise suitable logic, circuitry and/or code that may enable transfer of information to and/or from the device 104 via MTP and an extension of the MTP 106. The device 102 may be a media device that may comprise suitable processing 112 and storage capacity, for example internal storage 122 and/or external storage 132, for consuming and/or producing media objects. Moreover, the device 102 may be enabled to function as an initiator device with regard to MTP operations. The device 102 may be for example, a host computer or PC or media server.

The device 104 may comprise suitable logic, circuitry, and/or code that may enable transfer of information to and/or from the device 102 via MTP and an extension of the MTP 106. The device 104 may be a media device that may comprise suitable processing 114 and storage capacity, for example, internal storage 124 and/or external storage 134, for consuming and/or producing media objects. Moreover, the device 104 may be, for example, enabled to function as a responder device with regard to MTP operations. For example, the device 104 may be a still or video digital camera, a portable media player, a cell phone, a handheld medical device or PC.

The extension of the MTP 106 may comprise specifications within the MTP architecture that may enable managing by the device 102, MTP object IDs utilized by the device 104. An MTP object ID may be allocated to an MTP object stored on the device 104. In this regard, the object may comprise, for example, data, corresponding metadata and/or object reference data wherein the data may comprise audio and/or video files, text files, programs, scheduled events or contact information for example. The extension to the MTP 106 may comprise an ObjectID dataset for specifying object IDs in MTP operations as well as a plurality of MTP operations for an MTP initiator device to request action with respect to object IDs within an MTP responder device.

A pluraltiy of operations specified within the extension of the MTP 106 may be utilized to request action with respect to one or more specified object IDs. An exemplary MTP ObjectID dataset shown in Table 1, may be utilized as a parameter within MTP operations to specify an array of ObjectIDs. The array of objectIDs may specify a range of ObjectIDs and/or a set of individual ObjectIDs. For example, a range of ObjectIDs within the ObjectID dataset may be specified in the following manner:
Array [0]=n
Array [1]=0
Array [3]=n+m
   where n may represent the lowest value within the range of ObjectIDs, 0 may represent a hyphen and n+m may represent the greatest value within the range of ObjectIDs. Moreover, an array of individual ObjectIDs within the ObjectID dataset may be represented in the following exemplary manner.
Array [0]=0×12099ff
Array [1]=0×388
Array [3]=0×ffe45

TABLE 1
ObjectID Dataset

| | Field | Size | | |
|---|---|---|---|---|
| Field name | order | (bytes) | Datatype | Description |
| ObjectIDArray | 1 | Variable | AUINT32 | Array of Object ID's |

In various embodiments of the invention, an extension of the MTP may comprise a ReserveObjectIDs operation that may allow an MTP initiator, for example device 102, to request reservation of one or more ObjectIDs on a responder device 104, for example, during an MTP session. In instances where the responder approves the request and reserves the one or more ObjectIDs, the initiator may release the reserved objectIDs by closing the MTP session. The ObjectIDs may be specified within the ReserveObjectIDs operation with an ObjectID dataset. An exemplary ReserveObjectIDs operation may be defined as described in Table 2.

TABLE 2
ReserveObjectIDs Operation

| | |
|---|---|
| Operation Code | 0xXXXX |
| Operation Parameter 1 | None |
| Operation Parameter 2 | None |
| Operation Parameter 3 | None |
| Operation Parameter 4 | None |
| Operation Parameter 5 | None |
| Data | ObjectID Dataset |
| Data Direction | I->R |
| Response Code Options | OK, Parameter_Not_Supported, |
| | Invalid_Parameter |
| Response Parameter 1 | None |
| Response Parameter 2 | None |
| Response Parameter 3 | None |
| Response Parameter 4 | None |
| Response Parameter 5 | None |

In addition, an MTP initiator, for example device 102, may change one or more ObjectIDs on a responder device such as device 104 with a ChangeObjectIDs operation shown in Table 3. The one or more ObjectIDs to be modified may be specified by an ObjectID dataset sent as a parameter within the ChangeObjectIDs operation. Within the ObjectID dataset, old and new ObjectIDs may be specified in the following exemplary manner:
Array [n]=existing ObjectID
Array [n+1]=new ObjectID
   where n is an array position wherein the existing OjbectID may occur and n+1 is an array position where the new ObjectID that may substitute for the old ObjectID occurs.

TABLE 3
ChangeObjectIDs Operation

| | |
|---|---|
| Operation Code | 0xXXXX |
| Operation Parameter 1 | None |
| Operation Parameter 2 | None |
| Operation Parameter 3 | None |
| Operation Parameter 4 | None |
| Operation Parameter 5 | None |
| Data | ObjectID Dataset |
| Data Direction | I->R |
| Response Code Options | OK, Parameter_Not_Supported, |
| | Invalid_Parameter |
| Response Parameter 1 | None |
| Response Parameter 2 | None |
| Response Parameter 3 | None |
| Response Parameter 4 | None |
| Response Parameter 5 | None |

A SearchForObjectIDs operation, shown in Table 4, may be utilized by an MTP initiator to search fo one or more ObjectIDs on an MTP responder device. In instances where the one or more target ObjectIDs are found, a response code of OK may be returned to the initiator device.

TABLE 4
SearchForObjectIDs Operation

| | |
|---|---|
| Operation Code | 0xXXXX |
| Operation Parameter 1 | None |
| Operation Parameter 2 | None |
| Operation Parameter 3 | None |
| Operation Parameter 4 | None |
| Operation Parameter 5 | None |
| Data | ObjectID Dataset |
| Data Direction | I->R |
| ResponseCode Options | OK, Parameter_Not_Supported, |
| | Invalid_Parameter, error |
| Response Parameter 1 | None |
| Response Parameter 2 | None |
| Response Parameter 3 | None |
| Response Parameter 4 | None |
| Response Parameter 5 | None |

In operation, device 102 shown in FIG. 1 may be a host computer that may be enabled to function as an MTP initiator and the device 104 may be enabled to function as an MTP responder. The device 104 may be for example a handheld media device, such as a SmartPhone, enabled to store objects and corresponding MTP ObjectIDs. The device 102 may be a PC for example. The devices 102 and 104 may support the MTP extension 106 comprising one or more datasets and operations for managing ObjectIDs. In an exemplary embodiment of the invention, the device 102 may reserve one or more ObjectIDs on the device 104 prior to downloading one or more objects that may be assigned the one or more ObjectIDs. In addition, the device 102 may change and ObjectID by utilizing the ChangeObjectIDs operation. Moreover, the device 102 may search for one or more ObjectIDs stored on the device 104 utilizing the SearchForObjectIDs operation. In various embodiments of the invention, the device 102 may search for ObjectIDs within a range. In this manner, MTP operations may be utilized for cataloging information on the device 104 for example.

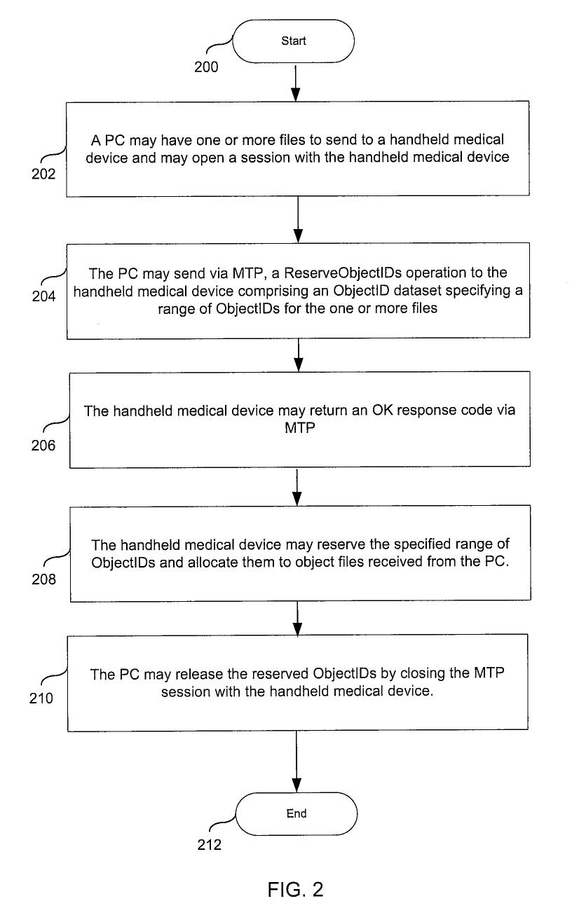

FIG. 2 is a flow chart illustrating exemplary steps for reserving via a first device, one or more ObjectIDs for utilization within a second device, in accordance with an embodiment of the invention. Referring to FIG. 2, after start step 200, in step 202, a PC, for example, the device 102 may have one or more files to send to a handheld medical device, for example, device 104 and may open a session with the handheld medical device 104. In step 204, the PC device 102 may send via MTP, a ReserveObjectIDs operation to the handheld medical device 104 comprising an ObjectID dataset specifying a range of Object IDs for the one or more files. In step 206, the handheld medical device 104 may return an OK response code via MTP. In step 208, the handheld medical device 104 may reserve the specified range of Object IDs and allocate them to object files received from the PC 102. In step 210, the PC 102 may release the reserved ObjectIDs by closing the MTP session with the handheld medical device 104. Step 212 may be the end of exemplary steps.

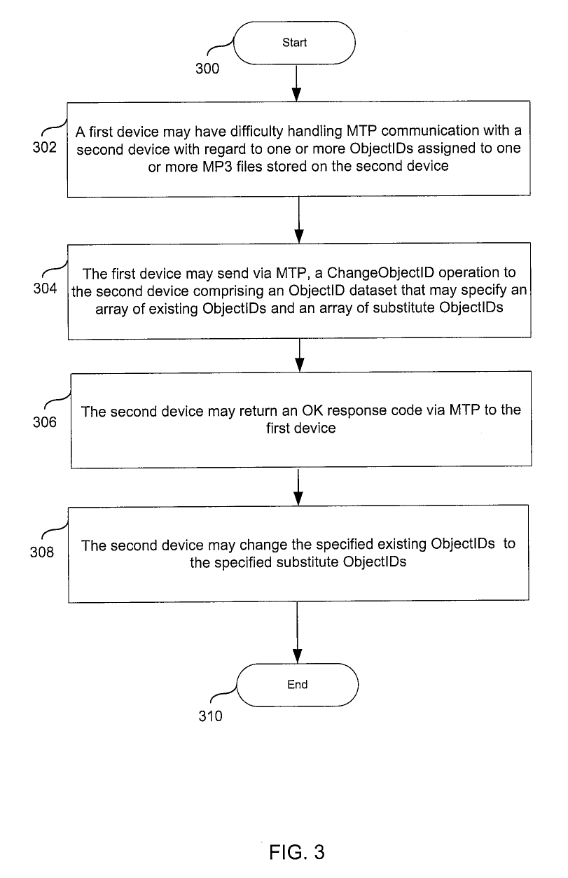

FIG. 3 is a flow chart illustrating exemplary steps for changing via a first device, one or more object IDs utilized within a second device, in accordance with an embodiment of the invention. Referring to FIG. 3, after start step 300, in step 302, first device 102 may have difficulty handling MTP communication with a second device 104 with regard to one or more ObjectIDs assigned to one or more MP3 files stored on the second device 104. In step 304, the first device 102 may send via MTP, a ChangeObjectID operation to the second device 104 comprising an ObjectID dataset that may specify an array of existing Object IDs and an array of substitute object IDs. In step 306, the second device 104 may return an OK response code via MTP to the first device 102. In step 308, the second device 104 may change the specified existing Object IDs to the specified substitute Object IDs. Step 310 may be an end of exemplary steps.

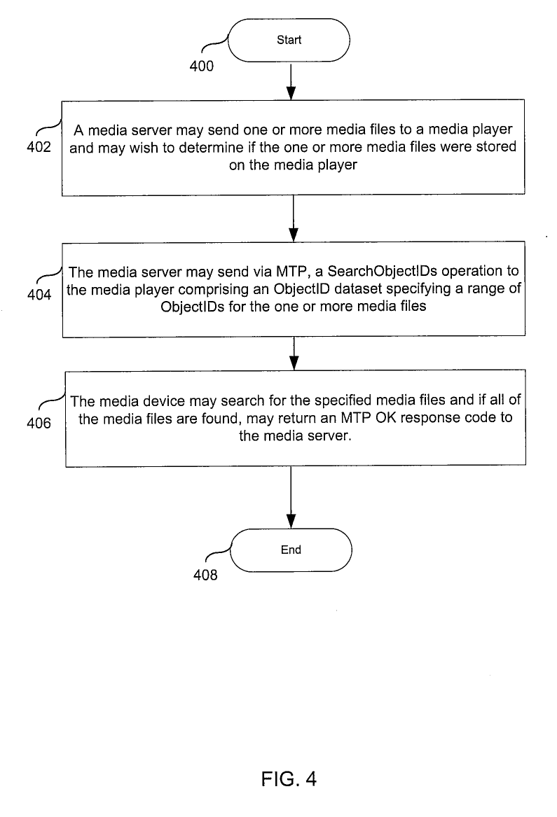

FIG. 4 is a flow chart illustrating exemplary steps for searching via a first device, for one or more ObjectIDs utilized within a second device, in accordance with an embodiment of the invention. Referring to FIG. 4, after start step 400, in step 402 a media server that may be similar or substantially the same as device 102 may send one or more media files to a media player which may be similar or substantially the same as device 104, and may wish to determine whether the one or more media files were stored on the media player 104. In step 404, the media server 102 may send via MTP, a SearchObjectIDs operation to the media player 104 comprising an ObjectID dataset specifying a range of ObjectIDs for the one or more media files. In step 406, the media device 104 may search for the specified media files and if all of the media files are found, may return an MTP OK response code to the media server 102. Step 408 may be the end of exemplary steps.

In an exemplary embodiment of the invention, an extension of media transfer protocol (MTP) 106 may enable a first device 102 to manage operations involving one or more object identifiers (ObjectIDs) stored within a second device 104 wherein the first device 102 and/or second device 104 may be enabled to communicate via MTP protocol. The ObjectIDs may correspond to one or more objects that may be currently stored within the second device 104 or may be subsequently stored within the second device 104. Moreover, one or more ObjectIDs may be specified in an array within an ObjectID dataset. For example, the one or more ObjectIDs may be expressed as a range of ObjectIDs within the array and/or as one or more ObjectID values within the array. In addition, MTP operations initiated by a first device 102 may enable management of ObjectIDs stored within a second device 104. For example, MTP operations may be utilized by the first device 102 to make a request pertaining to ObjectIDs on the second device 104. In this manner, a first device 102 may request reservation of one or more ObjectIDs within the second device 104. The first device 102 may also request changing of one or more ObjectIDs corresponding to one or more objects stored within the second device 104. Moreover, a search for one or more ObjectIDs stored within the second device 104 may be requested by the first device 102. Subsequent to the MTP requests by the first device 102 for management of ObjectIDs stored within the second device 104, the first device 102 may receive one or more MTP responses from the second device 104.

Another embodiment of the invention may provide a machine and/or computer readable storage and/or medium, having stored thereon, a machine code and/or a computer program having at least one code section executable by a machine and/or a computer, thereby causing the machine and/or computer to perform the steps as described herein for protocol operations and datasets to manage object identification numbers.

Accordingly, aspects of the invention may be realized in hardware, software, firmware or a combination thereof. The invention may be realized in a centralized fashion in at least one computer system or in a distributed fashion where different elements are spread across several interconnected computer systems. Any kind of computer system or other apparatus adapted for carrying out the methods described herein is suited. A typical combination of hardware, software and firmware may be a general-purpose computer system with a computer program that, when being loaded and executed, controls the computer system such that it carries out the methods described herein.

One embodiment of the present invention may be implemented as a board level product, as a single chip, application specific integrated circuit (ASIC), or with varying levels integrated on a single chip with other portions of the system as separate components. The degree of integration of the system will primarily be determined by speed and cost considerations. Because of the sophisticated nature of modern processors, it is possible to utilize a commercially available processor, which may be implemented external to an ASIC implementation of the present system. Alternatively, if the processor is available as an ASIC core or logic block, then the commercially available processor may be implemented as part of an ASIC device with various functions implemented as firmware.

The present invention may also be embedded in a computer program product, which comprises all the features enabling the implementation of the methods described herein, and which when loaded in a computer system is able to carry out these methods. Computer program in the present context may mean, for example, any expression, in any language, code or notation, of a set of instructions intended to cause a system having an information processing capability to perform a particular function either directly or after either or both of the following: a) conversion to another language, code or notation; b) reproduction in a different material form. However, other meanings of computer program within the understanding of those skilled in the art are also contemplated by the present invention.

While the invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiments disclosed, but that the present invention will include all embodiments falling within the scope of the appended claims.

What is claimed is:

1. A method for managing multimedia information, the method comprising:
managing by a first device enabled to communicate with a second device via Media Transfer Protocol (MTP), operations involving one or more object identifiers (ObjectIDs) stored within said second device.

2. The method according to claim 1, comprising specifying said one or more ObjectIDs as an array within an ObjectID dataset.

3. The method according to claim 2, comprising specifying said one or ObjectIDs within said array as a range of ObjectIDs.

4. The method according to claim 2, comprising specifying said one or ObjectIDs within said array as one or more ObjectID values.

5. The method according to claim 1, comprising requesting by said first device reservation of one or more ObjectIDs within said second device utilizing an MTP operation.

6. The method according to claim 1, comprising requesting by said first device, a change in one or more ObjectIDs corresponding to said one or more objects stored on said second device utilizing an MTP operation.

7. The method according to claim 1, comprising requesting by said first device, a search for one or more ObjectIDs stored on said second device utilizing an MTP operation.

8. The method according to claim 1, comprising receiving at said first device, an MTP response corresponding to said managing from said second device.

9. The method according to claim 1, wherein said one or more ObjectIDs corresponds to one or more objects stored within said second device.

10. A system for managing multimedia information, the system comprising:
one or more processors in a first device operable to communicate with a second device via Media Transfer Protocol (MTP), wherein said one or more processors manages operations involving one or more object identifiers (ObjectIDs) stored within said second device.

11. The system according to claim 10, wherein said one or more processors are operable to specify said one or more ObjectIDs as an array within an ObjectID dataset.

12. The system according to claim 11, wherein said one or more processors are operable to specify said one or ObjectIDs within said array as a range of ObjectIDs.

13. The system according to claim 11, wherein said one or more processors are operable to specify said one or ObjectIDs within said array as one or more ObjectID values.

14. The system according to claim 10, wherein said one or more processors are operable to request reservation of one or more ObjectIDs within said second device utilizing an MTP operation.

15. The system according to claim 10, wherein said one or more processors are operable to request a change in one or more ObjectIDs corresponding to said one or more objects stored on said second device utilizing an MTP operation.

16. The system according to claim 10, wherein said one or more processors are operable to request a search for one or more ObjectIDs stored on said second device utilizing an MTP operation.

17. The system according to claim 10, wherein said one or more processors are operable to receive an MTP response corresponding to said managing from said second device.

18. The system according to claim 10, wherein said one or more ObjectIDs corresponds to one or more objects stored within said second device.

19. A machine-readable storage having stored thereon, a computer program having at least one code section for managing multimedia information, the at least one code section being executable by a machine for causing the machine to perform steps comprising:
managing by a first device enabled to communicate with a second device via Media Transfer Protocol (MTP), operations involving one or more object identifiers (ObjectIDs) stored within said second device.

20. The machine-readable storage according to claim 19, wherein said at least one code section comprises code for specifying said one or more ObjectIDs as an array within an ObjectID dataset.

21. The machine-readable storage according to claim 20, wherein said at least one code section comprises code for specifying said one or ObjectIDs within said array as a range of ObjectIDs.

22. The machine-readable storage according to claim 20, wherein said at least one code section comprises code for specifying said one or ObjectIDs within said array as one or more ObjectID values.

23. The machine-readable storage according to claim 19, wherein said at least one code section comprises code for requesting by said first device, reservation of one or more ObjectIDs within said second device utilizing an MTP operation.

24. The machine-readable storage according to claim 19, wherein said at least one code section comprises code for requesting by said first device, a change in one or more ObjectIDs corresponding to said one or more objects stored on said second device utilizing an MTP operation.

25. The machine-readable storage according to claim 19, wherein said at least one code section comprises code for requesting by said first device, a search for one or more ObjectIDs stored on said second device utilizing an MTP operation.

26. The machine-readable storage according to claim 19, wherein said at least one code section comprises code for receiving at said first device, an MTP response corresponding to said managing from said second device.

27. The machine-readable storage according to claim 19, wherein said one or more ObjectIDs corresponds to one or more objects stored within said second device.
